(19) United States
(12) Patent Application Publication
(10) Pub. No.: US 2026/0299587 A1
(43) Pub. Date: Oct. 1, 2026

(54) CONTROL DEVICE, CONTROL METHOD, AND STORAGE MEDIUM

(71) Applicant: HONDA MOTOR CO., LTD., Tokyo (JP)

(72) Inventor: Naoki Mori, Tokyo (JP)

(21) Appl. No.: 19/541,431

(22) Filed: Feb. 17, 2026

(30) Foreign Application Priority Data
Mar. 28, 2025 (JP) 2025-056500

(51) Int. Cl. G05D 1/243; G01C 21/00; G06T 7/73; G05D 111/10

(52) U.S. Cl. CPC G05D 1/243; G01C 21/3837; G06T 7/74; G05D 2111/17

(57) ABSTRACT

A control device includes a sensor information acquisition unit configured to acquire information on the basis of a result of detection by a sensor, a feature point detection unit configured to detect a feature point on the basis of a result of acquisition by the sensor information acquisition unit, and a storage unit configured to store information on a feature amount including the feature amount in two-dimensional space on the basis of a result of detection by the feature point detection unit, in which the storage unit is capable of storing a feature amount of each feature point by associating a corresponding feature point when the feature point is detected with a relative position of the sensor.

### CROSS-REFERENCE TO RELATED APPLICATION

This application is based upon and claims the benefit of priority from Japanese Patent Application No. 2025-056500, filed Mar. 28, 2025, the entire contents of which is incorporated herein by reference.

### BACKGROUND

### FIELD OF THE INVENTION

The present invention relates to a control device, a control method, and a storage medium.

### DESCRIPTION OF RELATED ART

Conventionally, there is known a technology for detecting surrounding conditions using a sensor of a camera mounted on a moving body and generating a map. For example, Japanese Unexamined Patent Application, First Publication No. 2022-137532 discloses a technology for extracting feature points from detection data acquired by an on-board detector mounted in a host vehicle and generating a map using the extracted feature points.

However, this conventional technology described above does not take into account a relative position of the on-board detector with respect to a corresponding feature point when the feature point is extracted. In such cases, particularly for two- dimensional feature points such as image feature points, the feature amount for the same feature point may vary depending on the relative position of the on-board detector. As a result, with the conventional technology, accuracy of matching between a feature amount recorded on a map and a feature amount acquired during self-position estimation of a moving body may be low, resulting in low accuracy of self-position estimation in some cases.

### SUMMARY

The present invention was made in consideration of such circumstances, and one of its objects is to provide a control device, a control method, and a storage medium that can improve the accuracy of self-position estimation by taking into account relative positions of feature points and sensors.

The control device, control method, and storage medium of this invention have employed the following configuration.
(1) A control device according to one aspect of the present invention includes a storage medium configured to store computer-readable instructions, and a processor connected to the storage medium, in which the processor executes the computer-readable instructions to acquire information on the basis of a result of detection by a sensor, detect a feature point on the basis of a result of the acquisition, and store information on the feature point, including a feature amount in two-dimensional space, in a storage unit on the basis of a result of the detection, and the storage unit is capable of storing a feature amount of each feature point by associating a corresponding feature point when the feature point is detected with a relative position of the sensor.
(2) A control device according to another aspect of the present invention includes a storage medium configured to store computer-readable instructions, and a processor connected to the storage medium, in which the processor executes the computer-readable instructions to acquire information on the basis of a result of detection by a sensor that is a camera, detect a feature point on the basis of an image captured by the camera, and store information on the feature point in a storage unit on the basis of a result of the detection, and the storage unit is capable of storing a feature amount of each feature point by associating a corresponding feature point when the feature point is detected with a relative position of the sensor.
(3) In the aspect of (1) or (2) described above, the relative position is a direction in which the sensor that has detected the feature point is present relative to the feature point at a time of detecting the feature point.
(4) In the aspect of (3) described above, when a feature point stored in the storage unit is detected on the basis of a result of current detection by the sensor, the processor estimates a current position of the moving body on the basis of information on the stored feature point, and the processor selects a feature amount to be used in estimation of a position of the moving body among a plurality of feature amounts stored for the feature point on the basis of a current relative position, and estimates a current position of the moving body on the basis of the selected feature amount.
(5) In the aspect of (4) described above, the processor complements a feature amount when a feature point is detected based on a relative position different from the relative position of the sensor on the basis of the result of detection by the sensor, and the processor estimates the current position of the moving body further on the basis of the complemented feature amount.
(6) In the aspect of (4) described above, the moving body includes a plurality of sensors, and each of the plurality of sensors has a different detection axis direction.
(7) In the aspect of (4) described above, the information on the feature point stored in the storage unit is acquired on the basis of a result of acquisition by the sensor mounted in the moving body.
(8) In the aspect of (4) described above, the processor communicates with an external portion of the moving body, the processor acquires, via communication, a result of acquisition by the sensor that acquires information on surroundings of another moving body or information on the feature point, and the processor estimates the position of the moving body on the basis of a result of the acquisition via communication.
(9) In the aspect of (8) described above, the processor estimates a feature amount when a feature point is detected based on the relative position, taking into account specifications of the other moving body on the basis of the result of the acquisition via communication.
(10) A control method according to still another aspect of the present invention includes, by a computer, acquiring information on the basis of a result of detection by a sensor, detecting a feature point on the basis of a result of the acquisition, and storing information on the feature point including a feature amount in two-dimensional space in a storage unit on the basis of a result of the detection, in which the storage unit is capable of storing a feature amount of each feature point by associating a corresponding feature point when the feature point is detected with a relative position of the sensor.
(11) A computer-readable non-transitory storage medium according to still another aspect of the present invention is a storage medium that stores a program causing a computer to execute acquiring information on the basis of a result of detection by a sensor, detecting a feature point on the basis of a result of the acquisition, and storing information on the feature point including a feature amount in two-dimensional space in a storage unit on the basis of a result of the detection, in which the storage unit is capable of storing a feature amount of each feature point by associating a corresponding feature point when the feature point is detected with a relative position of the sensor.

According to the aspects of (1) to (11), accuracy of self-position estimation can be improved by taking into account a relative position of a feature point and a sensor.

According to the aspects of (2), (4), and (6), a data acquisition speed can be increased while improving the accuracy of self-position estimation.

According to the aspect of (5), the accuracy of self-position estimation can be improved by complementing feature amounts from angles not stored in the storage unit.

According to the aspect of (7), the accuracy of self-position estimation can be improved by accumulating feature point data acquired by a host vehicle.

According to the aspect of (8), the accuracy of self-position estimation can be improved by utilizing feature point data acquired by other vehicles.

According to the aspect of (9), feature point data acquired by other vehicles can be effectively utilized by complementing differences in specifications of the host vehicle and other vehicles.

### BRIEF DESCRIPTION OF THE DRAWINGS

FIG. 1 is a configuration diagram of a vehicle system including a control device according to an embodiment.

FIG. 2 is a diagram which shows an example of feature point information extracted by a feature point information extraction unit.

FIG. 3 is a diagram for describing complementary processing executed by a feature point information complementation unit.

FIG. 4 is a diagram which shows an example of map information created by a map creation unit and stored in a storage unit.

FIG. 5 is a diagram for describing correction processing of feature point information acquired from other vehicles.

FIG. 6 is a flowchart which shows an example of a flow of map creation processing executed by a control device.

FIG. 7 is a flowchart which shows an example of a flow of self-position estimation processing executed by the control device.

### DESCRIPTION OF EMBODIMENTS

Embodiments of a control device, a control method, and a storage medium of the present invention will be described below with reference to the drawings.

### Overall configuration

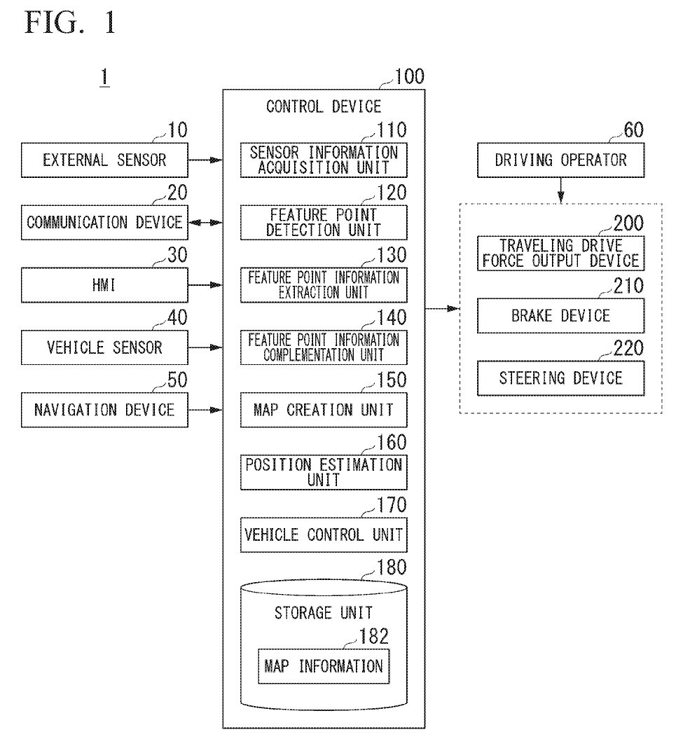

FIG. 1 is a configuration diagram of a vehicle system 1 including a control device 100 according to an embodiment. The vehicle (hereinafter referred to as a host vehicle M) in which the vehicle system 1 is mounted may be, for example, a two-wheeled, three-wheeled, or four-wheeled vehicle or micromobility. A drive source thereof may be an internal combustion engine such as a diesel engine or gasoline engine, an electric motor, or a combination of these. The electric motor operates using power generated by a generator connected to the internal combustion engine or discharged power from a battery (storage battery) such as a secondary battery or fuel cell. In the present embodiment, the host vehicle M is a vehicle with an autonomous driving function, that is, an autonomous vehicle, and is capable of traveling not only in an autonomous driving mode, in which no driver operation is required, but also in a manual driving mode, in which the driver performs a driving operation. In this case, the control device 100 may provide driving assistance to the driver. Furthermore, in the present embodiment, the host vehicle M in which the control device 100 is mounted is assumed to be a passenger car. However, the control device 100 may also be mounted in, for example, in addition to vehicles, other moving bodies, such as ships, aircraft, stand-up vehicles with power units, and micromobility vehicles such as electric kick scooters, or in terminal devices carried by pedestrians, such as smartphones and tablet terminals.

The vehicle system 1 includes, for example, an external sensor 10, a communication device 20, a human machine interface (HMI) 30, vehicle sensors 40, a navigation device 50, a driving operator 70, the control device 100, a traveling drive force output device 200, a brake device 210, and a steering device 220. These devices and equipment are connected to each other via multiplexed communication lines such as a controller area network (CAN) communication line, serial communication lines, a wireless communication network, or the like. Note that constituents shown in FIG. 1 are merely an example, and some constituents may be omitted or additional constituents may be added.

The external sensor 10 is a collective term for a plurality of sensors (external sensors) that detect external conditions, which is information on surroundings of the host vehicle M. In the present embodiment, the external sensor 10 is a digital camera that is mounted in the host vehicle M and uses a solid-state imaging element such as a charge coupled device (CCD) or complementary metal oxide semiconductor (CMOS). It may be a monocular camera (a wide-angle camera, fisheye camera, or omnidirectional camera), a compound eye camera (a stereo camera or multi-camera), or an RGB-D camera (a depth camera or ToF camera). In addition, for example, the external sensor 10 may be a light detection and ranging (LIDAR) sensor that irradiates a peripheral of the host vehicle M with light to measure scattered light, and detects a distance to an object on the basis of time between light emission and light reception, or a radar that emits radio waves (radar) such as millimeter waves to the vicinity of the host vehicle M and detects radio waves (reflected waves) reflected by an object in the vicinity to detect at least a position (distance and direction) of the object.

In the present embodiment, it is assumed that a plurality of cameras serving as the external sensors 10 are provided. As an example, the host vehicle M is equipped with a front camera 10-1 and a rear camera 10-2 (hereinafter, when there is no need to distinguish between the front camera 10-1 and the rear camera 10-2, they will be referred to as cameras 10). The front camera 10-1 is a camera installed to capture images in front of the host vehicle M, and is attached, for example, to a top of the front windshield, a back of the rearview mirror, a front of the vehicle body, or the like. The rear camera 10-2 is a camera installed to capture images behind the host vehicle M, and is attached, for example, to a top of the rear windshield, the back door, or the like. When images of the side are captured, the camera 10 may be attached, for example, to the left and right door mirrors. The camera 10, for example, periodically captures images in the vicinity of the host vehicle M.

The communication device 20 uses, for example, networks such as a cellular network, a Wi-Fi network, Bluetooth (registered trademark), dedicated short range communication (DSRC), a local area network (LAN), a wide area network (WAN), and the Internet to communicate with, for example, other vehicles in the vicinity of the host vehicle M, a terminal device of a user of the host vehicle M, or various server devices.

The human machine interface (HMI) 30 outputs various types of information to occupants (including a driver) of the host vehicle M and receives input operations from the occupants. The HMI 30 includes, for example, a display unit and a speaker. The display unit is, for example, a liquid crystal display (LCD) or an organic electro luminescence (EL) display device. The display unit displays various images (including video) in the embodiment. The display unit may be integrated with the input unit as a touch panel. The speaker outputs a predetermined sound (for example, an alarm sound or a message sound). The HMI 30 may also include a microphone, a buzzer, a touch panel, switches, keys, and the like. The switches may include a switch that executes or terminates predetermined driving control that can be executed by the vehicle control unit 170, which will be described below, or a switch that approves (permits) or rejects a driving control recommendation (proposal) from a system (the vehicle system 1). In addition, the switches may include a switch that performs a direction indication operation (a turn signal switch), and the like.

The vehicle sensors 40 include a vehicle speed sensor that detects a speed of the host vehicle M, an acceleration sensor that detects acceleration, and a yaw rate sensor that detects a yaw rate (for example, a rotational angular speed around a vertical axis passing through a center of gravity of the host vehicle M). The vehicle sensors 40 may also include a lateral acceleration sensor (lateral G sensor) that detects a lateral acceleration (lateral G) of the host vehicle M, a steering angle sensor that detects a steering angle of the host vehicle M (which may be the angle of the steering wheels or the operating angle of the steering wheel), a steering angular speed sensor that detects the steering angular speed, an orientation sensor that detects a direction of the host vehicle M, and a wheel speed sensor that detects the wheel speed, which is a rotational speed of front or rear wheels of the host vehicle M.

In addition, the vehicle sensors 40 may also include a position sensor that detects a position of the host vehicle M. The position sensor is, for example, a sensor that acquires position information (longitude and latitude information) from a global positioning system (GPS) device. Moreover, the position sensor may be, for example, a sensor that acquires the position information using a global navigation satellite system (GNSS) receiver in the navigation device 50. The vehicle sensors 40 may derive a speed of the host vehicle M based on a difference in position information (that is, a distance) over a predetermined period of time in the position sensor. Results detected by the vehicle sensor 40 are output to the control device 100.

The navigation device 50 includes, for example, a GNSS receiver, a navigation HMI, and a route determination unit. The navigation device 50 may hold map information in a storage device such as a hard disk drive (HDD) or flash memory, or may acquire map information 182 stored in a storage unit 180, which will be described below. The GNSS receiver specifies the position of the host vehicle M on the basis of signals received from the GNSS satellites. The position of the host vehicle M may be specified or complemented by an inertial navigation system (INS) that uses an output of the vehicle sensor 40. The navigation HMI includes a display device, a speaker, a touch panel, keys, and the like. The GNSS receiver may be provided in the vehicle sensor 40. The navigation HMI may be partially or entirely common to the HMI 30 described above.

The driving operator 70 includes, for example, a steering wheel, an accelerator pedal, and a brake pedal. The driving operator 70 may also include a shift lever, a variable steering wheel, a joystick, or other operators. Each operator of the driving operator 70 is equipped with an operation detection unit that detects an amount of operation of an operator or a presence or absence of an operation by the driver. The operation detection unit detects, for example, a steering angle and a steering torque of the steering wheel (for example, an amount of steering (a steering input torque) caused by a driving operation of the driver), a rate of change of steering torque, and amounts of depression of the accelerator pedal and the brake pedal. The operation detection unit then outputs results of the detection to the control device 100 or one or both of the traveling drive force output device 200, the brake device 210, and the steering device 220. The driving operator 70 may also include a direction indicator control unit (for example, a turn signal lever or a turn signal switch). When the direction indicator operation unit is operated, turn signal lamps of the host vehicle M associated with an operation content will light up (or blink), and the operation content (including, for example, a result of detecting the operation performed by the driver) is output to the control device 100.

### Control device

The control device 100 executes autonomous driving of the host vehicle M or executes various types of control to assist the driver in driving. The control device 100 includes, for example, a sensor information acquisition unit 110, a feature point detection unit 120, a feature point information extraction unit 130, a feature point information complementation unit 140, a map creation unit 150, a position estimation unit 160, a vehicle control unit 170, and a storage unit 180. The sensor information acquisition unit 110, the feature point detection unit 120, the feature point information extraction unit 130, the feature point information complementation unit 140, the map creation unit 150, the position estimation unit 160, and the vehicle control unit 170 are each realized by a hardware processor, such as a central processing unit (CPU), executing a program (software). Moreover, some or all of these components may be realized by hardware (a circuit unit; including circuitry), such as large scale integration (LSI), an application specific integrated circuit (ASIC), a field-programmable gate array (FPGA), a graphics processing unit (GPU), or a system on chip (SOC), or may be realized by software and hardware in cooperation. The program described above may be stored in advance in a storage device (a storage device with a non-transitory storage medium) such as a HDD or flash memory of the control device 100, or may be stored in a removable storage medium such as a DVD, CD-ROM, or memory card, and installed in the storage device of the control device 100 by the storage medium (non-transitory storage medium) being mounted in a drive device, a card slot, or the like.

### Detection of feature point

The sensor information acquisition unit 110 acquires an image captured by the camera 10 in time series. The images are an example of the "detection results" in the claims. The feature point detection unit 120 detects feature points from the captured images acquired by the sensor information acquisition unit 110. More specifically, for example, the feature point detection unit 120 extracts edges representing contours of objects from the captured image on the basis of brightness and color information for each pixel, and then uses the edge information to extract feature points. Feature points are, for example, intersections of edges, and correspond to corners of buildings, corners of road signs, or the like. Even if the external sensor 10 is a radar or lidar instead of a camera, feature points of objects around the host vehicle M can be extracted in a similar manner on the basis of the measured scattered light and radio waves.

### Extraction of feature point information

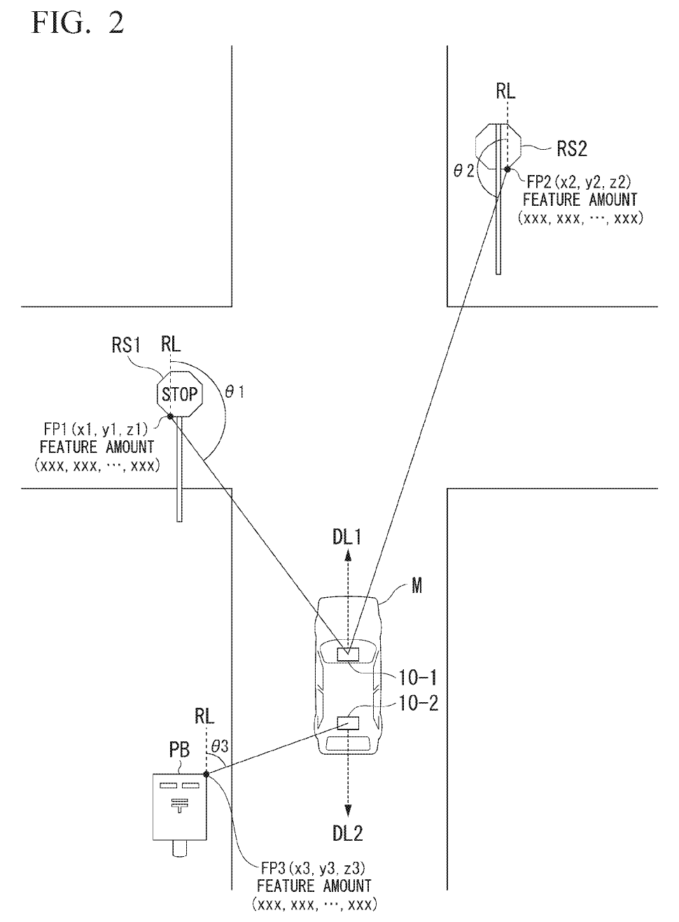

The feature point information extraction unit 130 extracts feature point information from the feature points detected by the feature point detection unit 120. FIG. 2 shows an example of the feature point information extracted by the feature point information extraction unit 130. In FIG. 2, symbols RS1 and RS2 each represent a road sign meaning "stop," a symbol PB represents a target object that is a mailbox, symbols FP1 and FP2 each represent a feature point detected from a road sign captured in an image captured by the front camera 10-1, and a symbol FP3 represents a feature point detected from a road sign captured in an image captured by the rear camera 10-2. In reality, many feature points are detected from road signs RS1 and RS2 and a target object PB, but for simplicity of description, FIG. 2 represents an example in which one feature point is detected from each of the road signs RS1 and RS2 and the target object PB.

Furthermore, in FIG. 2, symbols DL1 and DL2 represent detection axes of the front camera 10-1 and the rear camera 10-2, respectively. The detection axis DL1 is, for example, an axis that passes through a center of lens of the front camera 10-1 and extends perpendicular to the lens in an imaging direction. Similarly, the detection axis DL2 is, for example, an axis that passes through a center of lens of the rear camera 10-2 and extends perpendicular to the lens in the imaging direction. In other words, the front camera 10-1 and the rear camera 10-2 capture images that fall within a predetermined range centered on the detection axes DL1 and DL2, respectively. As shown in FIG. 2, the front camera 10-1 and the rear camera 10-2 have different detection axis directions, so that the feature point detection unit 120 can detect a large number of feature points from a single travel of the host vehicle M.

When a feature point is detected by the feature point detection unit 120, the feature point information extraction unit 130 extracts, as feature point information, for example, coordinates (three-dimensional coordinates) of a corresponding feature point relative to the position of the host vehicle M, an feature amount in two-dimensional space (that is, on the captured image), and a relative position of the feature point and the camera 10 when the feature point was detected. Here, the coordinates of the feature point relative to the host vehicle M are coordinates whose reference point (origin) is the position of the host vehicle M at a timing when the feature point detection unit 120 has started detecting a feature point (a timing when the feature point has been first detected). In this case, the origin may be any position, as long as it is uniquely determined for a purpose of creating the map information 182 which will be described below. The feature point information extraction unit 130 can then specify three-dimensional coordinates of the feature point in time series, for example by triangulation, on the basis of a plurality of images containing the same feature point captured in time series by the camera 10 and odometry information output from the vehicle sensor 40. Here, the odometry information refers to position information of the host vehicle M obtained by, for example, specifying a vehicle speed and a traveling direction of the host vehicle M on the basis of the left and right wheel speeds detected by a wheel speed sensor, and assuming that the host vehicle M traveled at the specified vehicle speed along the specified traveling direction from a known reference point. Alternatively, when the camera 10 is a compound eye camera or an RGB-D camera, the feature point information extraction unit 130 can specify the coordinates of the feature point from a single image.

Furthermore, the feature point information extraction unit 130 extracts, for example, information such as a shape (for example, curvature), lightness (for example, a brightness value), and color (for example, RGB color code) as feature amounts for the detected feature points in two-dimensional space (that is, on the captured image). FIG. 2 shows a situation in which the feature point information extraction unit 130 extracts color information for the feature points as feature amounts in two-dimensional space and expresses this information using high-dimensional vectors. In this case, for example, as shown in a feature point FP1 on the road sign RS1 and a feature point FP2 on the road sign RS2, even if a feature point corresponds to the same location on the same target object, the feature amount may vary depending on an angle at which the target object is photographed.

For example, in a case of FIG. 2, when the road sign RS1 is viewed from the host vehicle M facing forward, a red or white feature amount is extracted from the feature point of the road sign RS1. On the other hand, when the road sign RS1 is viewed from the host vehicle M facing backward, a gray feature amount is extracted from the same feature point of the road sign RS1. In other words, even if the feature point corresponds to the same location on the road sign RS1, the feature amount may vary depending on an angle at which the road sign RS1 is photographed. In this regard, in conventional technologies, when a feature point corresponding to the same location on the same target is photographed, a photographing angle is not taken into account, and different feature amounts may be acquired by photographing the same target in a different direction from during storage. In such a case, even if map information is referenced using the acquired feature amounts as a key, matching location information may not be present, resulting in a failure of self-position estimation.

In light of these circumstances, in the present embodiment, when a feature point is detected, the feature point information extraction unit 130 extracts a relative position of the feature point and the camera 10. Here, the relative position is information indicating a direction of the camera 10 that has detected the feature point relative to the feature point at a time of the detection. More specifically, for example, the feature point information extraction unit 130 can extract an angle θ formed between a line segment connecting the camera 10 (for example, a center of the camera 10) and the feature point and a reference line RL extending from the feature point as the relative position. The reference line RL may be set on the basis of an absolute reference, at least regardless of the position of the host vehicle M, and may be, for example, a specific direction (such as due north). In this manner, by using a reference line RL based on a feature point whose three-dimensional coordinates have been obtained, it is possible to store a relative position without a need for additional data, regardless of the position of the host vehicle M. FIG. 2 shows an example in which the feature point information extraction unit 130 extracts coordinates (x1,y1,z1), a feature amount, and a relative position θ1 as feature amount information for the feature point FP1 on the road sign RS1, coordinates (x2,y2,z2), a feature amount, and a relative position θ2 as feature amount information for the feature point FP2 on the road sign RS2, and coordinates (x3,y3,z3), a feature amount, and a relative position θ3 as feature amount information for a feature point FP3 on the target object PB.

As described above, in the present embodiment, coordinates, feature amounts, and relative positions are acquired for each feature point contained in each image captured by a plurality of cameras 10. As described above, a relative position indicates the direction of the camera 10 that has detected a feature point relative to the feature point. However, because there are countless variations in such a direction, accuracy of the created map information 182 may not be sufficient based solely on data of a direction actually measured by the camera 10.

### Complementation of feature point information

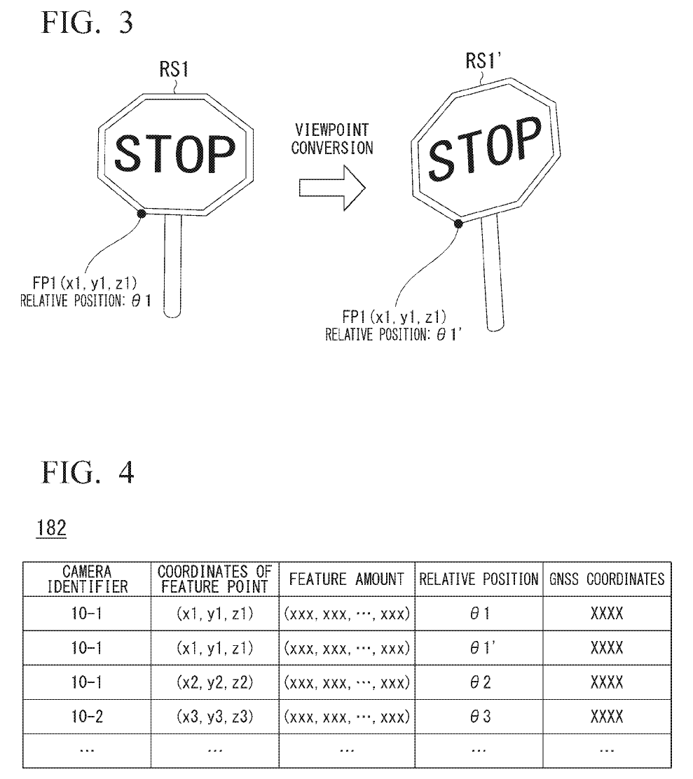

For this reason, the feature point information complementation unit 140 complements the feature amount when a feature point is detected based on a relative position different from a relative position of the camera 10 at a time of capturing an image, on the basis of the image captured by the camera 10. FIG. 3 is a diagram for describing complementary processing executed by the feature point information complementation unit 140. In FIG. 3, the left part represents road sign RS1 captured in the image captured by camera 10.

More specifically, for example, the feature point information complementation unit 140 can acquire a plurality of images of the road sign RS1 captured in different directions by performing viewpoint conversion processing such as neural radiance fields (NeRF) on an image of the road sign RS1. NeRF is a technology that generates free-viewpoint images based on a plurality of images captured from various angles. By using a neural network, it is possible to predict and represent with high accuracy a spatial shape of a target object and changes in light reflection and refraction according to a viewpoint. A right part of FIG. 3 shows an example in which the coordinates (x1,y1,z1) and the relative position θ1 of the feature point FP1 are converted to coordinates (x1,y1,z1) and a relative position θ1' as a result of viewpoint conversion processing executed by the feature point information complementation unit 140.

### Creation of map information

The map creation unit 150 creates the map information 182 on the basis of feature point information extracted by the feature point information extraction unit 130 and feature point information complemented by the feature point information complementation unit 140. More specifically, in the present embodiment, the map creation unit 150 uses a technology such as Visual SLAM (Simultaneous Localization and Mapping) to match identical feature points in images captured at different positions, and creates a 3D feature point map using triangulation and a bundle adjustment technology. After the map information 182 is created, the map creation unit 150 stores the created map information 182 in the storage unit 180.

FIG. 4 shows an example of the map information 182 created by the map creation unit 150 and stored in the storage unit 180. The map information 182 stores, for example, coordinates, a feature amount, a relative position, and GNSS coordinates of a detected feature point in association with an identifier of a camera that has detected the feature point. As shown in FIG. 4, when a map is created, the map creation unit 150 may also store GNSS coordinates of a feature point measured using a GNSS receiver. Generally, GNSS coordinates measured using a GNSS receiver contain errors. However, the bundle adjustment technology described above allows the measured GNSS coordinates to be optimized overall, thereby improving the accuracy of the GNSS coordinates stored in the map information 182. Moreover, when a map is created, the odometry information described above may be utilized to derive and store a current absolute position from previously obtained GNSS coordinates and records of the created map information 182.

Furthermore, as shown in FIG. 4, the map information 182 includes not only feature point information on a feature point detected from the image captured by the camera 10, but also feature point information on the feature point in a viewpoint-converted image obtained by performing viewpoint conversion on the image. In this manner, by performing viewpoint conversion, it is possible to improve the accuracy of the map information 182. Note that, for convenience of description, in the present embodiment, the control device 100 includes a map creation unit 150. However, the present invention is not limited to such a configuration, and the map creation unit 150 may be excluded from the control device 100 during a current position estimation phase which will be described below.

### Estimation of current position

The position estimation unit 160 estimates a current position of the host vehicle M based on the image captured by the camera 10 while the host vehicle M is traveling, on the basis of the map information 182. More specifically, while the host vehicle M is traveling, the position estimation unit 160 detects feature points from the image captured by the camera 10 and extracts feature point information from the detected feature points, similar to the processing executed by the feature point detection unit 120 and the feature point information extraction unit 130 described above. The position estimation unit 160 uses an identifier of the camera 10 and the extracted feature point information as keys and references the map information 182 to specify matching records. For example, when a difference between a combination of coordinates, feature amounts, and relative positions included in feature point information and a combination of coordinates, feature amounts, and relative positions included in a record stored in the map information 182 is within a threshold value, the position estimation unit 160 specifies the record as a matching record. On the basis of the matching record, the position estimation unit 160 can position (localization) the host vehicle M in the map information 182, which is a 3D feature point map. In actual operation, the position estimation unit 160 detects a large number of feature points from a single image, extracts feature point information from each feature point, and positions the host vehicle M so that a set of these feature points and feature point information is consistent with an entire record of the map information 182 (so that the difference is reduced).

As described above, compared to a conventional technology that does not take into account a direction in which a feature amount has been acquired for a feature point, according to the present embodiment, the feature amount of a feature point in two-dimensional space is stored in association with a relative position at a time when the feature point has been detected, and the map information 182 that takes the relative position into account is generated. As a result, it is possible to improve the accuracy of self-position estimation.

### Vehicle control

If the current position of the host vehicle M is estimated by the position estimation unit 160, the vehicle control unit 170 controls traveling of the host vehicle M on the basis of the estimated current position. For example, the vehicle control unit 170 detects free space in which the host vehicle M can travel from the set of feature points on the 3D feature point map represented by the map information 182, and controls the traveling drive force output device 200, the brake device 210, and the steering device 220 so that the host vehicle M travels through the detected free space. Moreover, for example, as driving assistance, the vehicle control unit 170 may display the current position of the host vehicle M and the free space on the 3D feature point map on the HMI 30. Furthermore, for example, when the control device 100 is mounted on a terminal device such as a smartphone or a tablet terminal, the control device 100 may cause a display unit of the terminal device to similarly display the current position of the host vehicle M and free space on the 3D feature point map.

The traveling drive force output device 200 outputs a traveling drive force (torque) for the vehicle to travel to the drive wheels. The traveling drive force output device 200 includes, for example, a combination of an internal combustion engine, a motor, a transmission, and the like, and an electronic control unit (ECU) that controls these. The ECU controls the configuration described above according to information input from the vehicle control unit 170 or information input from the driving operator 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor according to the information input from the vehicle control unit 170 or the information input from the driving operator 80 so that a brake torque according to a braking operation is output to each wheel. The brake device 210 may include a mechanism for transmitting a hydraulic pressure generated by an operation of a brake pedal included in the driving operator 80 to the cylinder via a master cylinder as a backup. The brake device 210 is not limited to the configuration described above, and may be an electronically controlled hydraulic brake device that controls an actuator according to the information input from the vehicle control unit 170 to transmit the hydraulic pressure of the master cylinder to the cylinder.

The steering device 220 includes, for example, a steering ECU and an electric motor. The electric motor applies force to, for example, a rack-and-pinion mechanism to change a direction of steering wheels. The steering ECU drives the electric motor to change the direction of the steering wheels in accordance with information input from the vehicle control unit 170 or information input from the driving operator 80.

### Communication with other vehicles

As described above, in the present embodiment, the control device 100 detects feature points from the image captured by the camera 10 while the host vehicle M is traveling, extracts feature point information from the detected feature points, and uses this information to create the map information 182. However, there is a limit to an amount of data that can be collected while the host vehicle M is traveling. For this reason, the communication device 20 may communicate with other vehicles to acquire images captured by cameras of the other vehicles and feature point information, along with an absolute position (for example, GNSS coordinates) at a time when the images and feature point information have been acquired. The control device 100 may use this information to create the map information 182. In this case, due to a discrepancy in specifications (overall length, overall width, overall height, and the like) between the host vehicle M and another vehicle, a difference may occur in relative positions of feature points as seen by the camera 10. For this reason, in the present embodiment, when the position estimation unit 160 acquires captured images or feature point information from another vehicle M1, it may correct the feature point information taking into account the discrepancy in the specifications between the host vehicle M and the other vehicle, and store the corrected information in the map information 182.

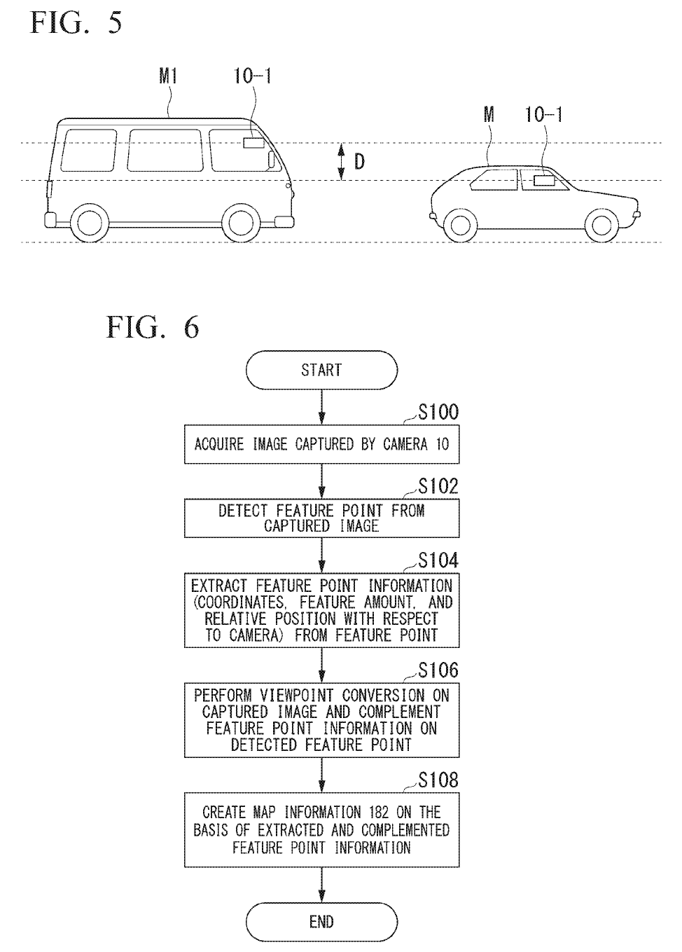

FIG. 5 is a diagram for describing correction processing of feature point information acquired from the other vehicle M1. In FIG. 5, the symbol M1 represents the other vehicle. FIG. 5 shows an example in which a difference occurs in relative positions of feature points as seen by the camera 10 due to a discrepancy in overall height between the host vehicle M and the other vehicle M1. The communication device 20 communicates with, for example, the other vehicle M1 to acquire specification information and feature point information of the other vehicle M1. At this time, the communication device 20 may acquire, in addition to the feature point information including coordinates, feature amounts, and relative positions, for example, GNSS coordinates at the timing when the feature points have been detected. The position estimation unit 160 then compares the specification information of the other vehicle M1 with the specification information of the host vehicle M. For example, in a case of FIG. 5, the position estimation unit 160 calculates that there is a difference in length D between an overall height of the host vehicle M and an overall height of the other vehicle M1. For this reason, the position estimation unit 160 corrects the relative position of the feature point information stored in the map information 182 by assuming that the front camera 10-1 of the host vehicle M is positioned vertically below the front camera 10-1 of the other vehicle M1 by a distance D. Such processing allows the feature point information of the other vehicle M1 to be used to create the map information 182 of the host vehicle M.

Note that in the embodiment described above, the relative position of the feature point is acquired as an angle (scalar value) on a two-dimensional plane. Alternatively, the relative position of the feature point may be acquired as an angle in three-dimensional space (for example, a combination of a polar angle and an azimuth angle). In this case, for example, the polar angle may be measured based on a vertical direction from the feature point, and the azimuth angle may be measured based on an XY plane of the map information 182. In this manner, by expressing the relative position of the feature point using an angle in three-dimensional space, discrepancy in specification with the other vehicle M1 can be reflected as discrepancy in angle. For example, discrepancy in overall height can be reflected as discrepancy in polar angle.

### Processing flow

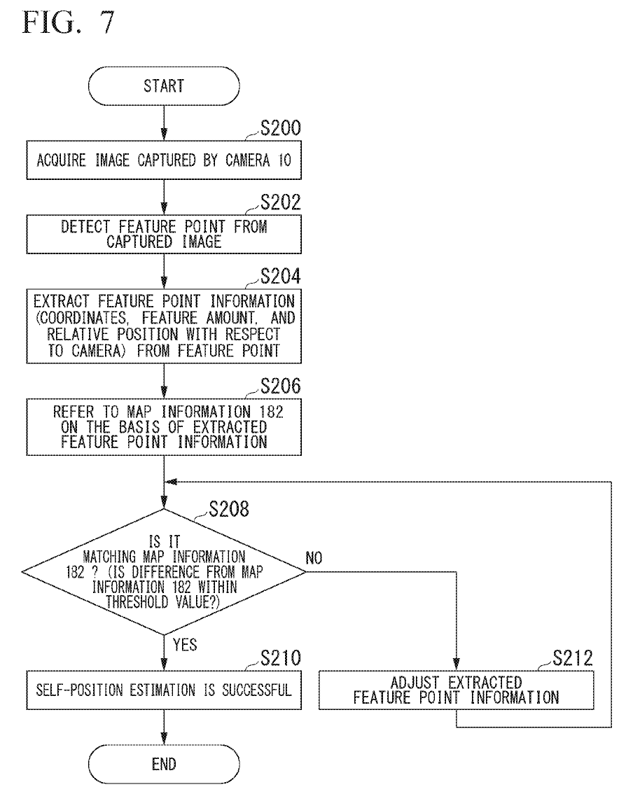

The processing flow executed by the control device 100 will be described below with reference to FIGS. 6 and 7. FIG. 6 is a flowchart which shows an example of a flow of map creation processing executed by the control device 100.

First, the sensor information acquisition unit 110 acquires an image captured by the camera 10 (step S100). Next, the feature point detection unit 120 detects feature points from the image captured by the camera 10 (step S102). Next, the feature point information extraction unit 130 extracts feature point information (coordinates, feature amounts, and relative positions with respect to the camera 10) from the detected feature point (step S104). Next, the feature point information complementation unit 140 performs viewpoint conversion on the captured image to complement feature point information from different relative positions of the detected feature points (step S106). Next, the map creation unit 150 creates the map information 182 on the basis of the extracted and complemented feature point information (step S108). As a result, processing of this flowchart will end. Note that in processing of the flowchart in FIG. 6, the processing of step S104 and the processing of step S106 may be reversed in order or may be executed simultaneously.

FIG. 7 is a flowchart which shows an example of a flow of self-position estimation processing executed by the control device 100. Processing of the flowchart shown in FIG. 7 is repeatedly executed while the host vehicle M is traveling.

First, the sensor information acquisition unit 110 acquires an image captured by the camera 10 (step S200). Next, the feature point detection unit 120 detects feature points from the image captured by the camera 10 (step S202). Next, the feature point information extraction unit 130 extracts feature point information (coordinates, feature amounts, and relative positions with respect to the camera 10) from the detected feature points (step S204). Next, the position estimation unit 160 refers to the map information 182 on the basis of the extracted feature point information (step S206).

Next, the position estimation unit 160 determines whether the extracted feature point information matches the map information 182 (whether there is a record in the map information 182 where the difference is within a threshold value) (step S208). When it is determined that the extracted feature point information matches the map information 182, the position estimation unit 160 specifies the position of the host vehicle M in the matching map information 182, and self-position estimation is successful (step S210). On the other hand, when it is determined that the extracted feature point information does not match the map information 182, the position estimation unit 160 changes the extracted feature point information (for example, adjusts at least one of the coordinates, feature amounts, and relative positions) (step S212). Thereafter, the position estimation unit 160 executes the processing of step S208 again. As a result, processing of this flowchart will end.

According to the present embodiment described above, for a feature point detected from an image, the feature amount of the feature point in two-dimensional space is stored in association with a relative position with respect to a sensor when the feature

point has been detected, and map information 182 is generated in which the relative position with respect to the sensor is taken into account for the feature amount. As a result, it is possible to improve the accuracy of self-position estimation.

The embodiment described above can be expressed as follows.

A control device includes a storage medium for storing computer-readable instructions, a processor connected to the storage medium, the processor executes the computer-readable instructions to: acquire information on the basis of a result of detection by a sensor; detect a feature point on the basis of a result of the acquisition; and store information on the feature point, including a feature amount in two-dimensional space, in a storage unit on the basis of a result of the detection, and the storage unit is capable of storing a feature amount of each feature point by associating a corresponding feature point when the feature point is detected with a relative position of the sensor.

Although a mode for carrying out the present invention has been described above using the embodiment, the present invention is not limited to the embodiment, and various modifications and substitutions can be made within a range not departing from the gist of the present invention.

What is claimed is:

1. A control device comprising:
a storage medium configured to store computer-readable instructions; and
a processor connected to the storage medium,
wherein the processor executes the computer-readable instructions to:
acquire information on the basis of a result of detection by a sensor,
detect a feature point on the basis of a result of the acquisition, and
store information on the feature point, including a feature amount in two-dimensional space, in a storage unit on the basis of a result of the detection, and
the storage unit is capable of storing a feature amount of each feature point by associating a corresponding feature point when the feature point is detected with a relative position of the sensor.

2. The control device according to claim 1,
wherein the sensor is a camera.

3. The control device according to claim 1,
wherein the relative position is a direction in which the sensor that has detected the feature point is present relative to the feature point at a time of detecting the feature point.

4. The control device according to claim 3,
wherein, when a feature point stored in the storage unit is detected on the basis of a result of current detection by the sensor, the processor estimates a current position of the moving body on the basis of information on the stored feature point, and
the processor selects a feature amount to be used in estimation of a position of the moving body among a plurality of feature amounts stored for the feature point on the basis of a current relative position, and estimates a current position of the moving body on the basis of the selected feature amount.

5. The control device according to claim 4,
wherein the processor complements a feature amount when a feature point is detected based on a relative position different from the relative position of the sensor on the basis of the result of detection by the sensor, and
the processor estimates the current position of the moving body further on the basis of the complemented feature amount.

6. The control device according to claim 4,
wherein the moving body includes a plurality of sensors, and
each of the plurality of sensors has a different detection axis direction.

7. The control device according to claim 4,
wherein the information on the feature point stored in the storage unit is acquired on the basis of a result of acquisition by the sensor mounted in the moving body.

8. The control device according to claim 4,
wherein the processor communicates with an external portion of the moving body,
the processor acquires, via communication, a result of acquisition by the sensor that acquires information on surroundings of another moving body or information on the feature point, and
the processor estimates the position of the moving body on the basis of a result of the acquisition via communication.

9. The control device according to claim 8,
wherein the processor estimates a feature amount when a feature point is detected based on the relative position, taking into account specifications of the other moving body on the basis of the result of the acquisition via communication.

10. A control method comprising:
by a computer,
acquiring information on the basis of a result of detection by a sensor;
detecting a feature point on the basis of a result of the acquisition; and
storing information on the feature point including a feature amount in two-dimensional space in a storage unit on the basis of a result of the detection,
in which the storage unit is capable of storing a feature amount of each feature point by associating a corresponding feature point when the feature point is detected with a relative position of the sensor.

11. A computer-readable non-transitory storage medium that stores a program causing a computer to execute:
acquiring information on the basis of a result of detection by a sensor,
detecting a feature point on the basis of a result of the acquisition, and
storing information on the feature point including a feature amount in two-dimensional space in a storage unit on the basis of a result of the detection,
wherein the storage unit is capable of storing a feature amount of each feature point by associating a corresponding feature point when the feature point is detected with a relative position of the sensor.
